(19) United States
(12) Patent Application Publication
(10) Pub. No.: US 2006/0139239 A1
(43) Pub. Date: Jun. 29, 2006

(54) Liquid crystal display device and projector

(76) Inventors: Toshio Maeda, Chiba (JP); Toshiki Misonou, Ichihara (JP); Yoshio Maruoka, Mobara (JP); Akihiro Watanabe, Mobara (JP); Haruhisa Iida, Chiba (JP); Eiichirou Itou, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/291,930

(22) Filed: Dec. 2, 2005

(30) Foreign Application Priority Data
Dec. 2, 2004 (JP) 2004-349324

(51) Int. Cl. G09G 3/18

(52) U.S. Cl. 345/50

(57) ABSTRACT

The present invention, in a projector, prevents the generation of a color domain which is generated attributed to the orientation direction having a pretilt angle. In a projector including a light source, a plurality of liquid crystal display panels which modify light irradiated from the light source, and a screen to which the light modified by the respective liquid crystal display panels is projected, the orientation direction of one liquid crystal display panel out of a plurality of liquid crystal display panels differs from the orientation direction of other liquid crystal display panels and the orientation directions of the liquid crystal display panels are aligned on the screen.

The present application claims priority from Japanese application serial No. 2004-349324, filed on (Dec. 2, 2004), the content of which is hereby incorporated by reference into this application.

### BACKGROUND OF THE INVENTION

1. Field of the Invention

The present invention relates to a liquid crystal display device and a projector, and more particularly to a liquid crystal display device and a projector which use reflective liquid crystal display panels.

2. Description of the Related Art

With respect to a liquid crystal display panel which uses vertical-orientation-type liquid crystal, in a reflective liquid crystal display panel, a light shielding film which constitutes a black matrix is not present and hence, a domain attributed to a lateral electric field is liable to be easily observed and a domain which is generated in the particular direction in the orientation having a pretilt angle has brought about the deterioration of the resolution.

Further, in a three-deflector projector, light irradiated from a light source is separated into three primary colors of R, G, B by polarization, separated lights are incident on three liquid crystal display panels and, thereafter, reflection lights are again synthesized by an optical system and a synthesized light is projected to a screen (see following patent documents 1 to 3).

On the other hand, with respect to an inspection pattern which is displayed on a display device such as a reflective liquid crystal display panel, optical makers and projector set makers have their own know-how.

The preparation of a pattern generator of high resolution of a HDTV casts a heavy burden on set makers. Further, the optical makers and projector set makers are reluctant to disclose the inspection patterns to the public. Accordingly, it is necessary for the set maker side to freely rewrite the pattern and to voluntarily develop a system.

A conventional projector system is constituted by connecting a personal computer (hereinafter referred to as “PC”) and a projector, wherein image data or the like which is transmitted to the projector from the PC is formed of analogue RGB signals or DVI digital signals.

Accordingly, when the image data is formed of the analogue signals, it is necessary to convert the digital data (an evaluation image of dot checkered pattern, a raster or the like, a still image such as a material of presentation) possessed on a PC side into analogue signals once and, thereafter, the data is outputted to the projector.

Further, the pattern generator of HDTV output for evaluating the panel compatible to the high resolution (HDTV) is extremely expensive. The pattern generator of digital signal output is also expensive. Further, the PC compatible to the HDTV is also expensive.

On the other hand, as shown in FIG. 30, each pixel of the reflective liquid crystal display panel or the like adopts a thin film transistor (SWa) having one-stage constitution and hence, sequential scanning shown in FIG. 31 is performed.

That is, in the related art, a line selection pulse of an H level is applied to gate lines G sequentially during one frame and hence, the thin film transistors (SWa) of the pixels of each display line are turned on whereby video signals inputted from a drain signal line D are written in liquid crystal capacitances Cc of the respective pixels.

Here, in FIG. 31, a quadrangular shape in which 1F is written expresses one frame.

Here, as the related art documents relevant to the present invention, following patent documents can be named.
[Patent document 1] JP-A-2004-163921
[Patent document 2] JP-A-2003-66459
[Patent document 3] JP-A-2002-268066

In the above-mentioned three-plate-type projector, due to the structure of the optical system, out of three liquid crystal display panels, one plate of liquid crystal display panel is inevitably synthesized in an inverted form in the lateral direction or in the vertical direction and hence, it is necessary to invert an image display on the panel.

Here, due to the orientation direction which possesses a pretilt angle, out of three liquid crystal display panels for RGB, one plate of liquid crystal display panel generates a domain in the direction opposite to the directions of domains of other liquid crystal display panels. Accordingly, on the screen, a complementary color of the domain of color which is generated in the different direction and the domain of color generated in the different direction on the opposite side appear and the complementary color is observed as the color bleeding thus giving rise to a drawback that the resolution feeling is remarkably deteriorated.

On the other hand, optical makers and set makers require a large number (naturally 10 to 100 sets) of PCs and pattern generators at a time for an image quality inspection, a lifetime test and the like. Although most of the inspection and the test are performed using still pictures, image other than logic patterns such as existing raster, color bars and the like are also necessary.

Particularly, vertical stripe images, lateral stripe images and monoscopic images, still images such as nature drawing for ghost evaluation and smear evaluation are necessary. Further, there exists a demand of the optical makers and the set makers for arbitrarily rewriting for every usage of the inspection and test.

In this manner, in the inspection of the display device such as the reflective liquid crystal display panel, several sets of PCs or pattern generators have been used heretofore. However, there has been a drawback that a system which can be rewritten more freely and at a lower cost is necessary.

Further, there has been also a drawback that image signals which are not degenerated are necessary in the image quality test of the panel corresponding to the high resolution such as HDTV.

Still further, a logic pattern incorporated in a penal controller cannot cover all items of the image inspection and, further, there has been a drawback that there exists no system which can perform a large amount of rewriting processing in the inside of the optical makers and the set makers or the like at a low cost.

On the other hand, conventionally, in each pixel of the liquid crystal display panel such as the reflective liquid crystal display panel, the transistor has the one-stage constitution and hence, there is no way but to sequentially write inputted video signals directly to the pixel.

The display on the liquid crystal display panel is a hold-type display and hence, a response time of the liquid crystal takes approximately several ms. Accordingly, when the transistor adopts the one-stage constitution, the difference in response is generated between an upper side and a lower side in the sequential writing.

Accordingly, there arises a state that videos of neighboring frames are overlapped to each other on the upper side and the lower side of the screen thus giving rise to the afterimage feeling at the time of performing the moving picture display.

Further, in driving the single-plate field sequential driving, unless the single-plate field sequential driving is performed in synchronism with the scroll processing of the color filter, there arises a drawback that colors are mixed.

### SUMMARY OF THE INVENTION

The present invention has been made to overcome the above-mentioned drawbacks of the related art and it is an object of the present invention to provide a technique which can prevent the generation of a color domain attributed to the orientation direction having a pretilt angle in a projector.

Further, it is another object of the present invention to provide a projector having an inspection pattern generating circuit which can perform the rewriting processing in the inside of an optical maker, a set maker or the like.

It is still another object of the present invention to provide a liquid crystal display device which can reduce an afterimage feeling at the time of moving picture display and can prevent the color mixing at the time of single-plate field sequential driving.

The above-mentioned and other objects and novel features of the present invention will become apparent by the description of this specification and attached drawing.

To briefly explain the summary of typical inventions among the inventions disclosed in this specification, they are as follows.

To achieve the above-mentioned object, a projector of the present invention is characterized in that as a liquid crystal display panel which is inverted laterally or vertically by an optical system, a liquid crystal display panel which differs from other liquid crystal display panels in the orientation direction is used, and the orientation directions of the respective liquid crystal display panel are arranged in the same direction on a screen.

Further, the projector of the present invention is characterized in that the orientation direction of the liquid crystal display panel is set to the direction which intersects the direction that the liquid crystal display panel is inverted laterally or vertically thus setting the direction at which a domain is generated to only the vertical direction or the lateral direction, whereby even when the display is performed using only one plate of the liquid crystal display panel inverted, the direction that the domain is generated is held at the same direction.

Further, the projector according to the present invention includes a control circuit which drives respective liquid crystal display panels, wherein the control circuit includes a pattern output circuit which generates and outputs an arbitrary pattern used in an inspection or a test, and a still image output circuit which generates and outputs an arbitrary still image used in the inspection or the test.

The pattern output circuit reads out pattern data corresponding to one vertical-stripe or lateral-stripe display line from a frame memory or a first memory (for example, EEPROM) and stores the pattern data in the frame memory and, at the same time, repeatedly reads out the pattern data corresponding to one vertical-stripe or lateral-stripe display line from the frame memory and generates a given vertical-stripe or lateral-strip pattern.

The still image output circuit reads out given still image data from an inner memory or a second memory (for example, a flash memory card) and stores the image data in the inner memory and, at the same time, reads out still image data from the inner memory and generates a given still image.

Further, according to the present invention, by adding a thin film transistor which functions as a switch element to each pixel of the liquid crystal display panel, video signals which are sequentially written are temporarily stored in the inside of the panel and, thereafter, the full-screen collective writing, the each-block collective writing or two-stage high-speed writing is performed.

According to the present invention, in all portions in the inside of the screen of the liquid crystal display panel, the response of the liquid crystal is finished substantially simultaneously and hence, it is possible to perform a film-like moving picture display and hence, an afterimage at the time of performing the moving picture display can be reduced whereby color mixing at the time of performing the single-plate field sequential driving can be obviated.

To briefly explain advantageous effects obtained by the typical inventions among the inventions disclosed in this specification, they are as follows.

(1) According to the present invention, by aligning the domain generating directions of the three liquid crystal display panels on the three-deflector projector on the screen, it is possible to eliminate the color bleeding attributed to the domain.

(2) According to the present invention, it is possible to provide the projector which includes the inspection pattern generating circuit which is capable of performing the rewriting processing in the inside of an optical maker, a set maker or the like.

(3) According to the present invention, it is possible to provide the liquid crystal display device which can reduce the afterimage feeling at the time of performing the moving picture display thus obviating the color mixing at the time of performing the single-plate field sequential driving.

### BRIEF DESCRIPTION OF THE DRAWINGS

FIG. 1 is a view showing three reflective liquid crystal display panels for a three-plate type projector according to an embodiment of the present invention;

FIG. 2 is a cross-sectional view showing one example of an optical engine used in the projector which adopts the reflective liquid crystal display panels;

FIG. 3 is a cross-sectional view showing another example of the optical engine used in the projector which adopts the reflective liquid crystal display panels;

FIG. 4 is a view showing a liquid crystal model in the vertical orientation in a state that a pretilt angle is given to liquid crystal such that the liquid crystal is tilted in the fixed direction when a voltage is applied;

FIG. 5 is a cross-sectional view showing the cross-sectional structure of the reflective liquid crystal display panel;

FIG. 6 is a view for explaining a mechanism in which a domain is generated attributed to a lateral electric field;

FIG. 7 is a view showing an example in which a white/black pattern is displayed in a vertical-orientation-type reflective liquid crystal display panel in which liquid crystal is oriented in the oblique direction of 45°, wherein when the view shows that the domain is generated at a portion where the orientation direction is changed from white to black;

FIG. 8 is a view showing a case in which a display is performed using three plates of reflective liquid crystal display panels having the same orientation direction in the optical system shown in FIG. 2;

FIG. 9 is a view showing a modification of the reflective liquid crystal display panels of the embodiment of the present invention;

FIG. 10 is a block diagram showing the system constitution of the three-deflector projector of an embodiment 2 of the present invention;

FIG. 11 is a block diagram for explaining an internal function of panel control LSIs (102R, 102G, 102B) shown in FIG. 10;

FIG. 12 is a view for explaining an operation of a stripe pattern output circuit shown in FIG. 11;

FIG. 13 is a view for explaining a method for generating a vertical stripe pattern in the stripe pattern output circuit shown in FIG. 11;

FIG. 14 is a view for explaining a method for generating a lateral stripe pattern in the stripe pattern output circuit shown in FIG. 11;

FIG. 15 is a view for explaining an operation of a still image output circuit shown in FIG. 11;

FIG. 16 is a view for explaining a method for generating a block pattern in a stripe pattern output circuit shown in FIG. 11;

FIG. 17 is a circuit diagram showing an equivalent circuit of a liquid crystal display panel of an embodiment 3 of the present invention;

FIG. 18 is a circuit diagram showing an equivalent circuit of a modification of the liquid crystal display panel of an embodiment 3 of the present invention;

FIG. 19 is a view for explaining the full screen collective writing in the liquid crystal display device of an embodiment 3 of the present invention;

FIG. 20 is a view for explaining the each-block collective writing in the liquid crystal display device of an embodiment 3 of the present invention;

FIG. 21 is a view for explaining the high-speed sequential writing in the liquid crystal display panel of an embodiment 3 of the present invention;

FIG. 22 is a view for explaining a change of an image displayed inside the screen when the collective writing of the embodiments of the present invention is performed and when the conventional sequential writing is performed;

FIG. 23 is a view for explaining changes of polarities of voltages held in respective pixels on each display line when the collective writing of the embodiment of the present invention is performed and when the conventional sequential writing is performed;

FIG. 24 is a view showing a timing chart when the collective writing of the embodiment of the present invention is performed and when the conventional sequential writing is performed;

FIG. 25 is a view for explaining a modification of a driving method of an embodiment 3 of the present invention;

FIG. 26 is a view for explaining a driving method shown in FIG. 25 and writing of a black video signal when the conventional sequential writing is performed;

FIG. 27 is a view showing a timing chart for inserting black by turning off a backlight in the embodiment 3 of the present invention;

FIG. 28 is a view for explaining the single-plate field sequential driving when the collective writing of the embodiment of the present invention is performed and when the conventional sequential writing is performed;

FIG. 29 is a schematic view for explaining a method for constituting one pixel of the liquid crystal display panel shown in FIG. 17;

FIG. 30 is a circuit diagram showing an equivalent circuit of the conventional liquid crystal display panel.

FIG. 31 is a view of a scanning method of the conventional liquid crystal display panel.

### DESCRIPTION OF THE PREFERRED EMBODIMENTS

Embodiments of the present invention are explained in details in conjunction with drawings hereinafter.

Here, in all drawings for explaining the embodiments, parts having the identical functions are given same symbols and the repeated explanation of these parts is omitted.

### Embodiment 1

FIG. 2 is a cross-sectional view showing one example of an optical engine which is used in a projector adopting reflective liquid crystal display panels.

In the example shown in FIG. 2, for example, a high-pressure mercury lamp is used as a light source 1, light from the high-pressure mercury lamp 1 is split into a red light and a cyan light by a first color splitting element 2, wherein the red light (R) is incident on the reflective liquid crystal display panel 21 through a polarization beam splitter (hereinafter referred to as PBS) 11.

The cyan light is split into a green light (G) and a blue light (B) by a second color splitting element 3 and these color lights are incident on the reflective liquid crystal display panels (22, 23) through respective PBSs (12, 13).

The irradiation lights from the respective reflective liquid crystal display panels (21, 22, 23) are synthesized by a color synthesizing element 15, a synthesized light is irradiated to a lens side and is projected to a screen. Here, the green irradiation light is directly irradiated to the lens side, while the red and blue irradiation lights are respectively reflected one time by the color synthesizing element 15 and are irradiated to the lens side and, thereafter, these lights are projected to the screen.

Accordingly, with respect to the red and blue lights, images which are displayed on the reflective liquid crystal display panels are displayed on the screen in a state that the images are inverted laterally and hence, the images of the red and blue lights assume a state different from the green light with respect to the lateral display direction.

In an actual product, the display of green is aligned with the displays of other colors by inverting the video signal scanning direction of the reflective liquid crystal display panel.

Here, when three reflective liquid crystal display panels have the same orientation direction, the displayed images are integrated on the screen due to the inversion of video signal. However, with respect to the orientation directions, only the green light assumes an inverted state in the lateral direction.

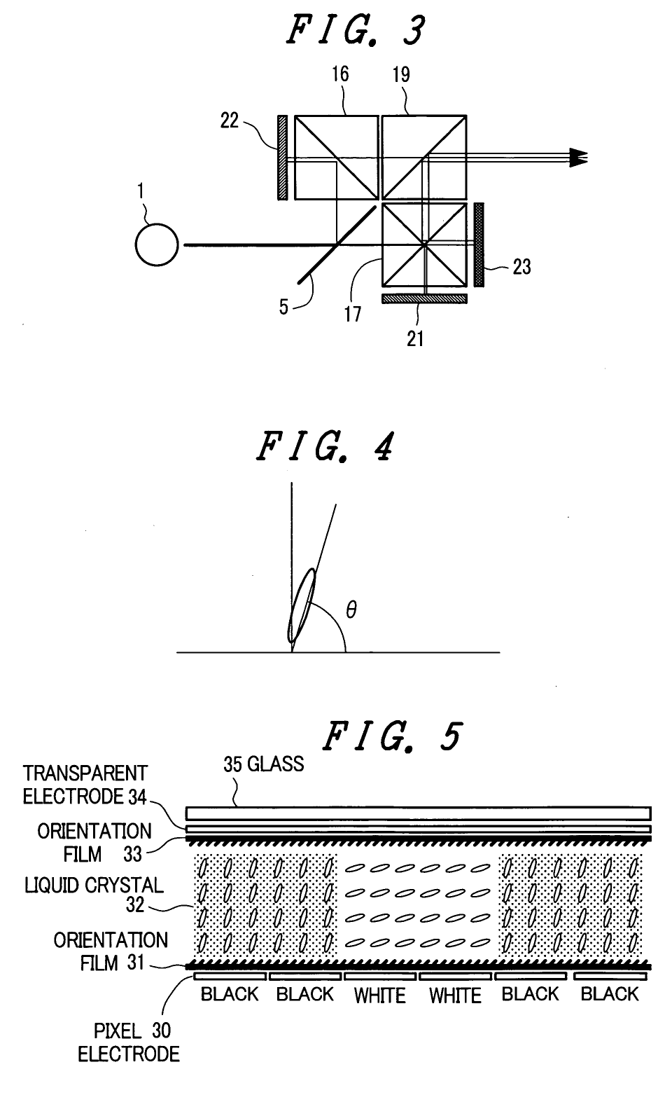

FIG. 3 is a cross-sectional view showing another example of an optical engine used in a projector which adopts reflective liquid crystal display panels.

In an example shown in FIG. 3, for example, using a high-pressure mercury lamp as a light source 1, light from the light source 1 is split into a green light, a red light and a blue light by a color splitting element 5, wherein the green light (G) is incident on a reflective liquid crystal display panel 22 through a PBS 16.

The red light (R) and the blue light (B) are incident on reflective liquid crystal display panels (21,23) through a PBS 17.

Irradiation lights from the respective reflective liquid crystal display panels (21, 22, 23) are synthesized by a color synthesizing element 19, and the synthesized light is irradiated to a lens side and is projected to a screen. Here, the green irradiation light is directly irradiated to the lens side, the red irradiation light is reflected one time by the color synthesizing element 19 and is irradiated to the lens side, and the blue irradiation light is reflected by the PBS 17 and the color synthesizing element 19 one time respectively and hence, the blue irradiation light is reflected twice in total and is irradiated to the lens side.

Accordingly, although the green light and the blue light have the same lateral display direction, the red light has the lateral display in an inverted state and hence, although it is possible to integrate the display on the screen by inverting the video signal, only the red light has the orientation direction in the laterally inverted state.

FIG. 4 shows a liquid crystal model having the vertical orientation and is also a view showing a state in which a pretilt angle is imparted to the liquid crystal to allow the liquid crystal to be tilted in a fixed direction at the time of applying a voltage to the liquid crystal.

FIG. 5 is a cross-sectional view showing the cross-sectional structure of the reflective liquid crystal display panel.

In the vertically oriented liquid crystal, liquid crystal molecules are raised at a portion to which the voltage is not applied and a black display is performed. By applying the voltage to the liquid crystal, the liquid crystal molecules are tilted in the orientation direction and a white display is performed.

Here, in FIG. 5, numeral 30 indicates a pixel electrode, numerals 31, 33 indicate orientation films, numeral 32 indicates liquid crystal, numeral 34 indicates a transparent electrode (a counter electrode), and numeral 35 indicates a glass substrate.

FIG. 6 is a view for explaining a mechanism which generates a domain attributed to a lateral electric field.

Although the lateral electric field is generated in a boundary between a white portion and a black portion due to the voltage applied to the white portion, in a boundary portion which is changed from black→white in the orientation direction, the lateral electric field works in the white portion in the direction which turns down the liquid crystal and hence, the boundary portion is not influenced. However, in a boundary portion which is changed from white→black in the orientation direction, the liquid crystal which is turned down in the inverse-tilting direction is generated in the white portion due to the lateral electric field. This is a phenomenon referred to as a domain and becomes a phenomenon in which the white-black boundary portion becomes blurred.

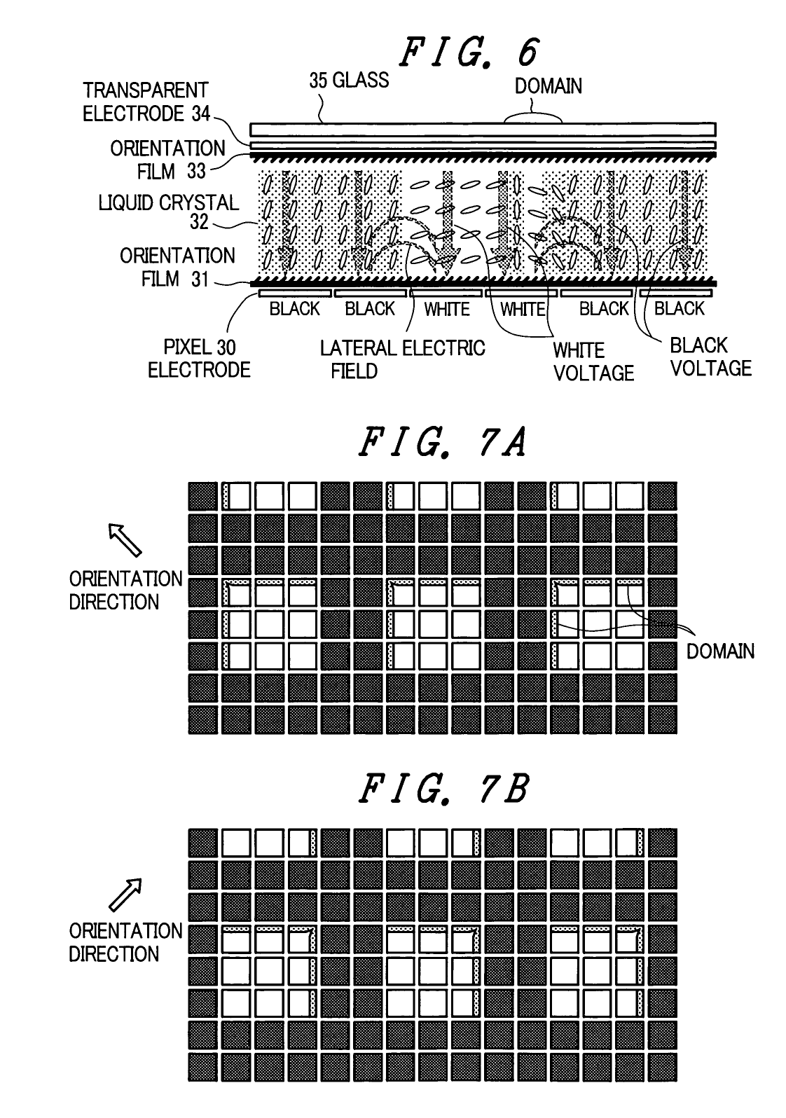

FIG. 7A and FIG. 7B are views showing an example which indicates a white-black pattern in a vertical-orientation reflective liquid crystal display panel which is inclined at an oblique angle of 45°, wherein a domain is generated at a portion where the color is changed from white→black in the orientation direction.

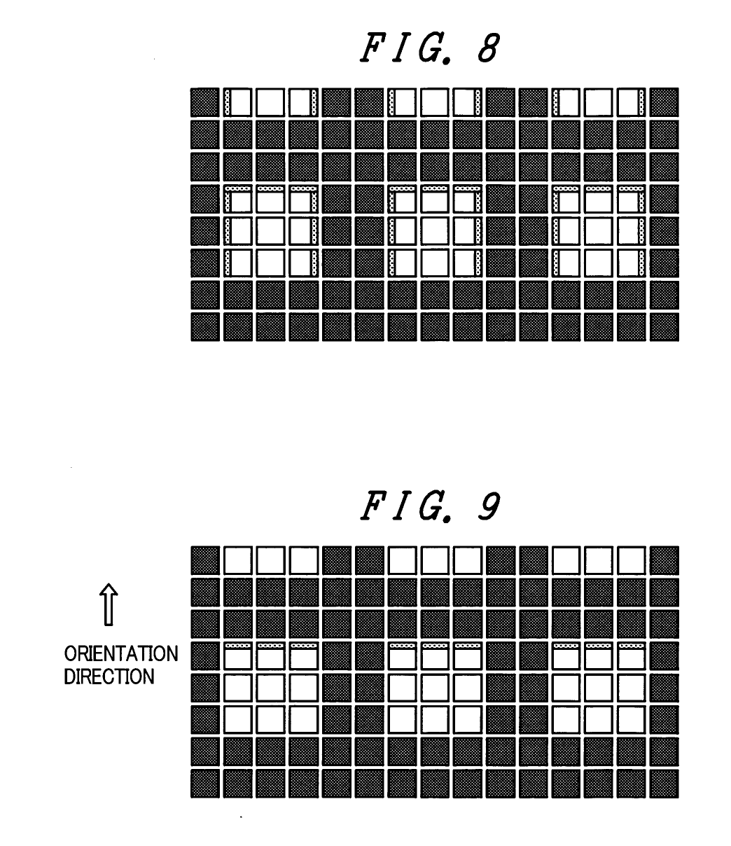

With respect to the red light and the blue light, the domain is generated on the screen as shown in FIG. 7A, while with respect to the green light, the domain is generated as shown in FIG. 7B. FIG. 8 shows the screen that red and blue displayed in FIG. 7A and green displayed in FIG. 7B

Accordingly, on the screen, as shown in FIG. 8, the color bleeding of green and magenta is recognized thus remarkably damaging the resolution feeling.

FIG. 8 shows a case in which the display is performed using three reflective liquid crystal display panels having the same orientation direction in the optical system shown in FIG. 2.

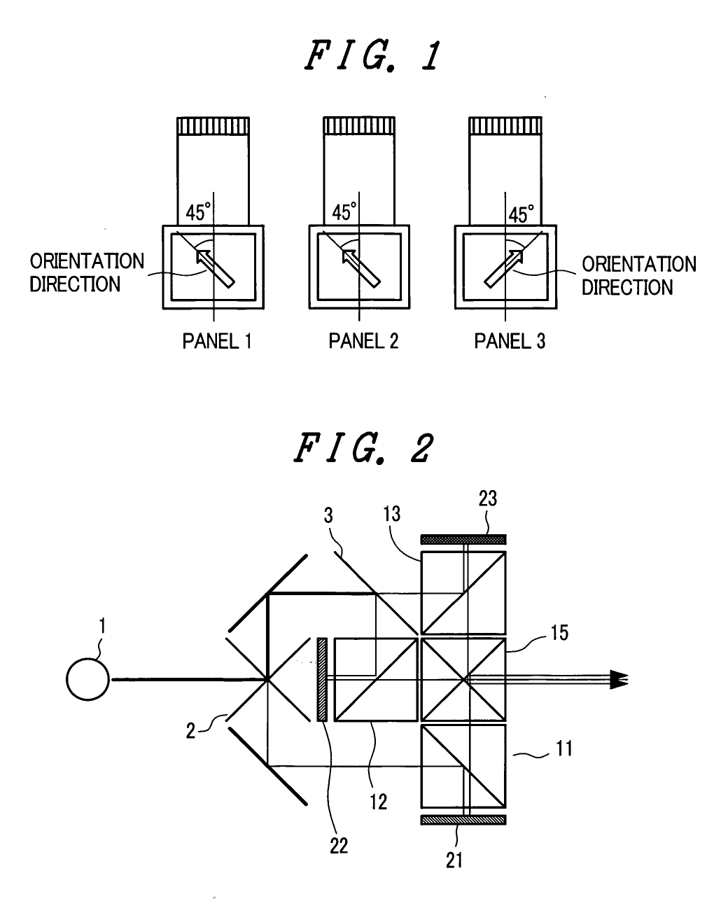

FIG. 1 is a view showing three reflective liquid crystal display panels for a three deflector projector of the embodiment according to the present invention.

FIG. 1 shows a case in which, among three reflective liquid crystal display panels, as one reflective liquid crystal display panel (panel 3), a liquid crystal display panel having liquid crystal whose orientation direction is different by 90 degrees from other reflective liquid crystal display panels (panels 1, 2) is used.

As in the case of this embodiment, among three reflective liquid crystal display panels, by combining the green reflective liquid crystal display panel whose orientation direction is different by 90 degrees from the orientation direction of liquid crystal of other red and blue reflective liquid crystal display panels, on the screen, the orientation directions of the liquid crystal of three reflective liquid crystal display panels are arranged in the direction (shown in FIG. 7A) and hence, there is no possibility that the color bleeding is generated.

FIG. 9 is a view showing a modification of the embodiment of the present invention.

In an example shown in FIG. 9, a following system is adopted. That is, in an optical system which inverts a display of one reflective liquid crystal display panel in the lateral direction for aligning the video display directions on the screen, by setting the orientation direction of the liquid crystal of the reflective liquid crystal display panel to 0° instead of 45°, the domain generation direction is limited to one side irrespective of the panel display direction on the screen.

### Embodiment 2

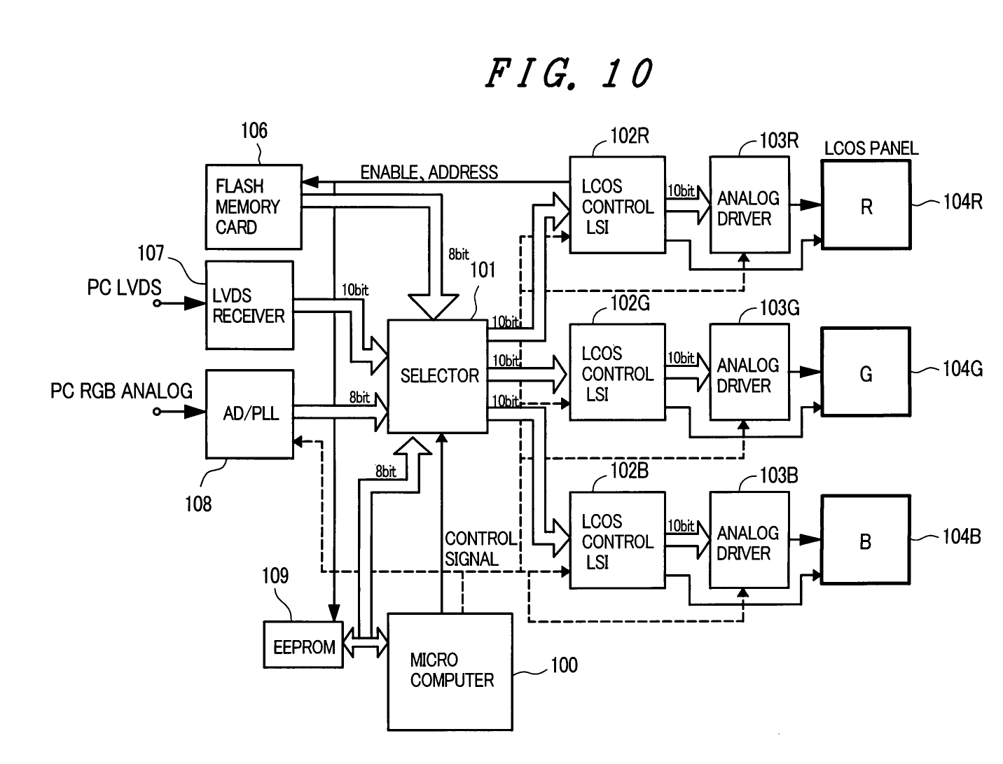

FIG. 10 is a block diagram showing the system constitution of the three-deflector projector of the embodiment 2 of the present invention.

A video signal inputted from an external portion of the projector has several formats, wherein image-fetching circuits which conform to the respective formats are prepared. An analogue video signal is converted into a digital signal by an AD/PLL circuit 108 and is inputted to a LCOS (Liquid Crystal on Silicon) panel control LSIs (102R, 102G, 102B) through a selector 101.

Further, a digital video signal is inputted to the panel control LSIs (102R, 102G, 102B) through various interface circuits (LDVS, DVI and the like) and the selector 101. FIG. 10 illustrates a case in which the digital video signal is inputted through a LVDS receiver 107.

The video signal which is inputted to the panel control LSIs (102R, 102G, 102B) and is subjected to signal processing is subjected to the D/A conversion by analogue drivers (103R, 103G, 103B) and an analogue signal is inputted to reflective liquid crystal display panels (104R, 104G, 104B).

The panel control LSIs (102R, 102G, 102B) shown in FIG. 10 are formed of a LCOS (Liquid Crystal on Silicon) panel control LSI which incorporates rewritable evaluation pattern generation circuits (a rewritable stripe pattern output circuit and a rewritable still image output circuit) therein.

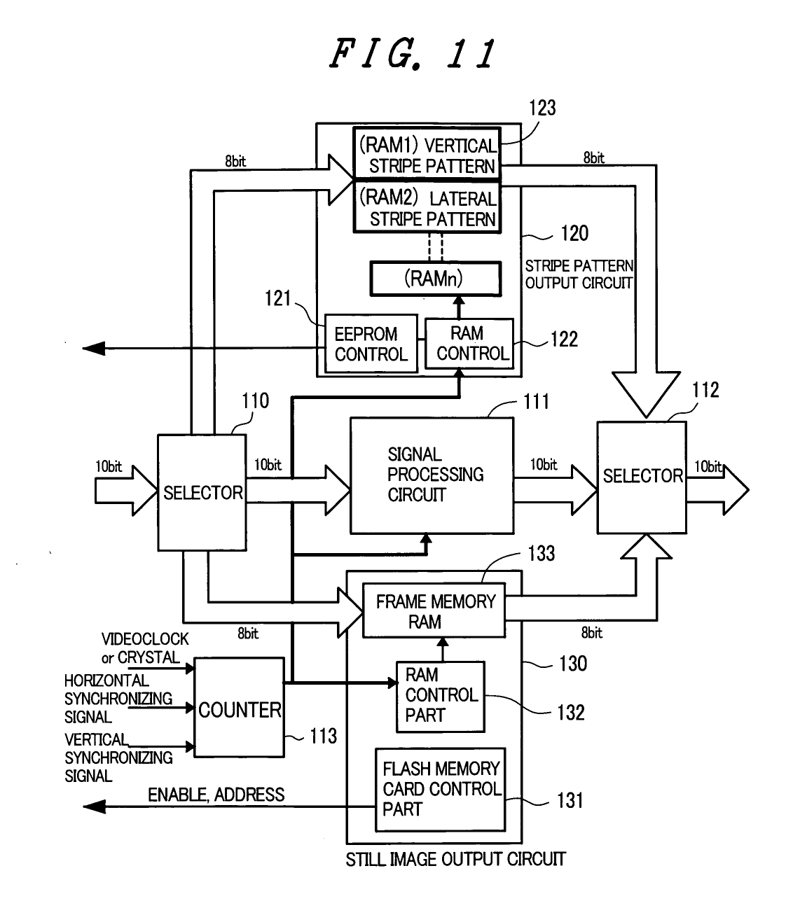

FIG. 11 is a block diagram for explaining an internal function of the panel control LSIs (102R, 102G, 102B) shown in FIG. 10.

A usual moving picture video signal passes a selector 110 in a preceding stage, is processed in a signal processing circuit 111, and is outputted after passing through a selector 112 in a succeeding stage.

The signal processing circuit 111 performs the signal processing such as the conversion of a data rate of the video signal, the γ correction and the like. Further, in conformity with the video signal, various drive pulses necessary for driving the liquid crystal panel are generated and, at the same time, signals of logic patterns such as a simple raster, gray scales, a checkered pattern, a grid pattern and the like are also outputted.

Here, when the display signal is a digital signal, the display signal is inputted to the signal processing circuit through various interface circuits (LVDS, DVI and the like).

Next, a rewritable stripe pattern output circuit 120 and a still image output circuit 130 are explained.

In reading the data for stripe pattern, first of all, when a control signal and a reading start signal from a data setting microcomputer 100 shown in FIG. 10 are inputted to the panel control LSIs (102R, 102G, 102B), an EEPROM control part 121 outputs addresses corresponding to an enable signal and a reading start signal and the data on the addresses are read out from an EEPROM (Electrically Erasable and Programmable ROM) 109.

The read data is inputted to the panel control LSIs (102R, 102G, 102B) through the selector 110 and is developed in a RAM 123 in the inside of the panel control LSIs.

The developed data is repeatedly read out from the RAM 123 by a RAM control part 122 in synchronism with a horizontal synchronizing signal and a vertical synchronizing signal used in a counter 113 in the inside of the panel controls LSI.

To prevent the disturbance of the display image attributed to the RAM writing, it is also possible to preserve the read data in other elements besides a display-screen-use RAM.

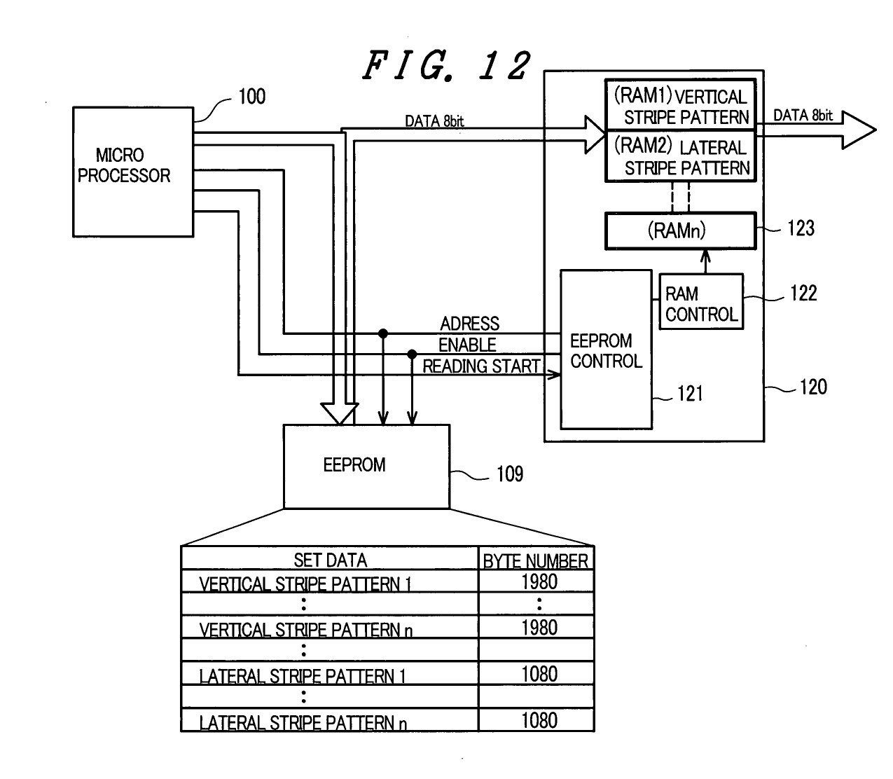

FIG. 12 is a view for explaining the manner of operation of the stripe pattern output circuit 120 shown in FIG. 11.

In FIG. 12, the stripe pattern data is registered in an external EEPROM 109 through the data setting microcomputer 100. Here, in the registration, data corresponding to 1 line can be registered in the external EEPROM 109 in plural numbers.

In a HDTV (1980×1080), the vertical stripe requires a capacitance of 8 bits and 1980 bytes for every 1 line and the lateral stripe requires a capacitance of 8 bits and 1080 bytes for every 1 line.

The reading is performed such that when a reading start signal is inputted to the panel control LSIs (102R, 102G, 102B) by the data setting microcomputer 100, an EEPROM control part 121 in the panel control LSI outputs addresses corresponding to an enable signal and a reading start signal and the data is read out from the EEPROM 109.

The read data is developed in RAMs 123 corresponding to the data in the inside of the panel control LSI. The developed stripe data is outputted by the RAM control part 122.

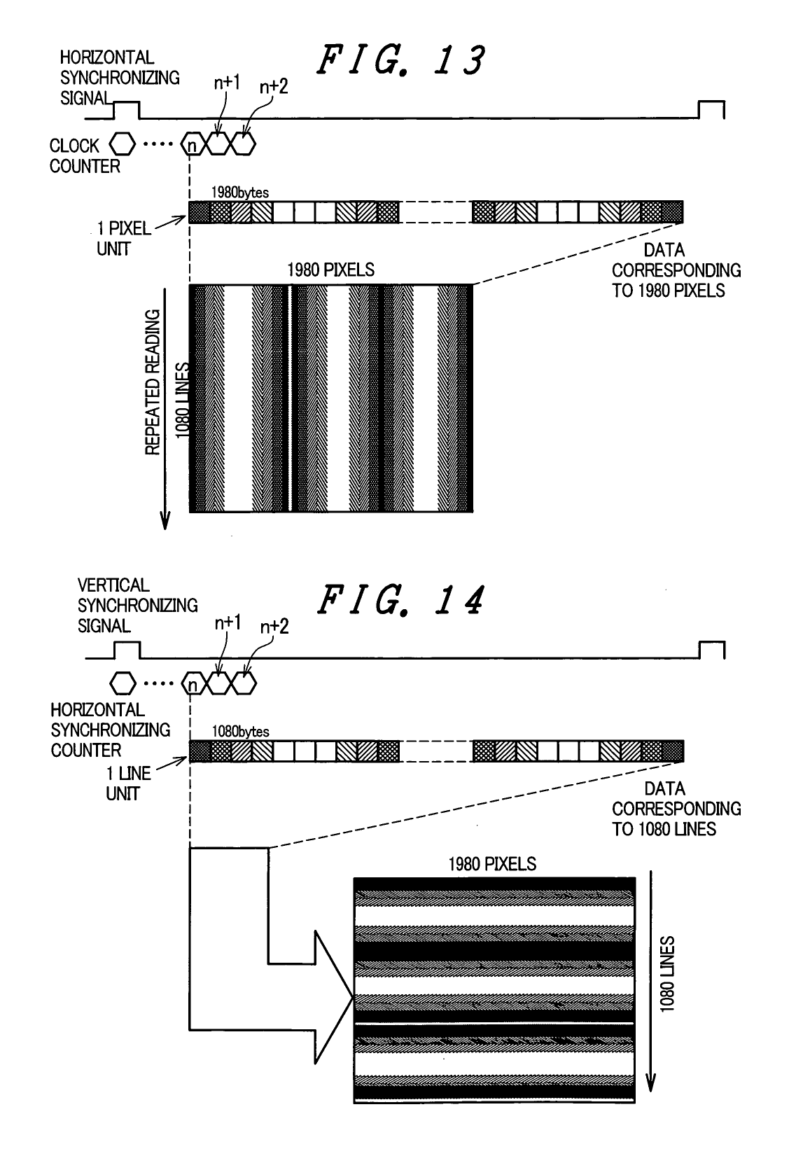

As shown in FIG. 13, in the HDTV, with respect to the vertical stripe, data corresponding to 1980 bytes is repeatedly outputted at the pixel timing in synchronism with a horizontal synchronizing signal.

Further, as shown in FIG. 14, with respect to the lateral stripe, data corresponding to 1080 bytes is repeatedly outputted at the horizontal synchronizing timing in synchronism with a vertical synchronizing signal.

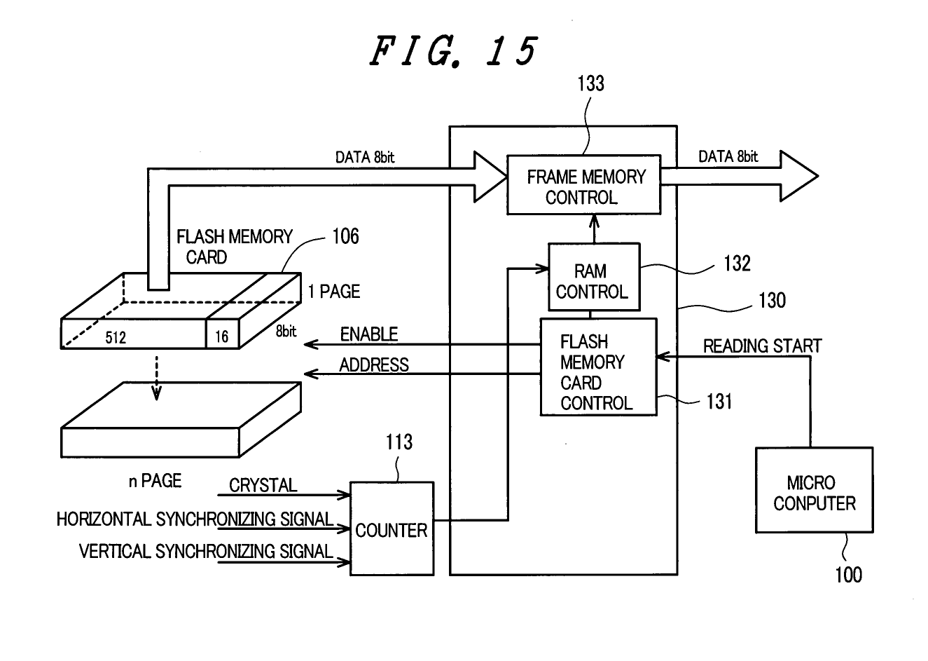

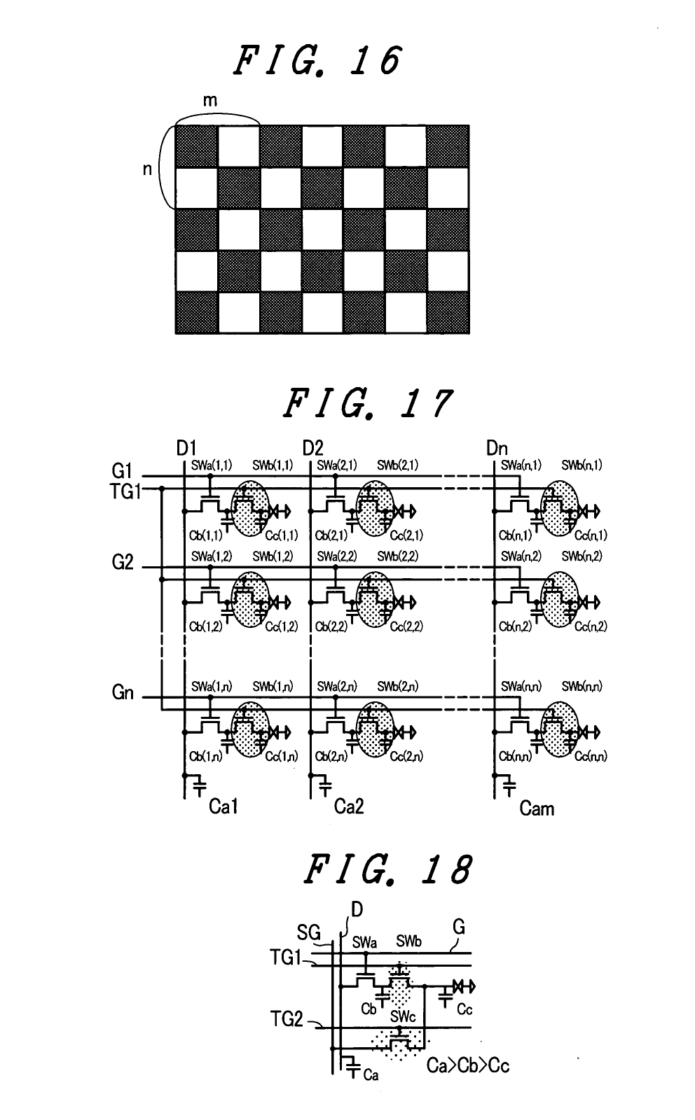

Further, in FIG. 12, by setting the data written in the EEPROM 109 every unit block (an arbitrary size of vertical n×lateral m=nm bytes) instead of every 1 line, by combining methods shown in FIG. 13 and FIG. 14, it is possible to perform the display a checkered pattern shown in FIG. 16 at an arbitrary size.

The still image output circuit 130 shown in FIG. 11, when a control signal and a reading start signal from the data setting microcomputer 100 shown in FIG. 10 are inputted to the panel control LSIs (102R, 102G, 102B), outputs addresses corresponding to an enable signal and the reading start signal from a flash memory card control part 131, and reads the data from the flash memory card 106. The data is written in the frame memory RAM 133 through the selector 110.

When the data corresponding to one image is read, the data is outputted by the RAM control part 132 in synchronism with the horizontal synchronizing signal which constitutes an external video signal generated by a counter 113 or a horizontal synchronizing signal which is generated by a crystal on a circuit.

FIG. 15 is a view for explaining an operation of the still image output circuit 130 shown in FIG. 11.

In FIG. 15, based on the reading start signal and the address in the data setting microcomputer 100, the flash memory card control part 131 in the inside of the panel control LSI generates the control signal of the flash memory card 106.

The data read from the flash memory card 106 for every several hundreds (for example, 528 in smart media) bytes in 1 page is developed in the frame memory RAM 133 in the inside of the panel control LSI.

A read quantity and read times can be arbitrarily changed depending on a kind and the capacitance of the flash memory card.

Thereafter, in synchronism with the horizontal synchronizing signal which constitutes an external video signal generated by the counter 113 or the horizontal synchronizing signal which is generated by the crystal on the circuit, the data is read from the frame memory RAM 133 for every 1 line by a RAM control part 132. For example, with respect to the HDTV, the data of 1080 lines are read and the still image of the HDTV is repeatedly displayed on the reflective liquid crystal display panels (104R, 104G, 104B).

It is sufficient for the panel control LSIs (102R, 102G, 102B) to have the frame memory RAM 133 corresponding to the HDTV (1980×1080×8 bit) as an extra.

In rewriting, the above-mentioned processing is repeated based on the reading start signal and the address of the data setting microcomputer 100.

Here, in the above-mentioned explanation, the image processing of the HDTV size is taken as the example. However, the image having the smaller size can be displayed by performing the substantially equal processing, while there arises no problem in displaying the image having the larger size by increasing the incorporated RAM capacitance.

Further, by exchanging panel control LSIs (102R, 102G, 102B) incorporating the rewritable stripe pattern output circuit and the rewritable still image output circuit and the selector 101 of this embodiment with the conventional panel control LSI and selector, in the conventional projector, it is possible to read out the still image data of the flash memory card 106 and the projector evaluation pattern data of the EEPROM 109, not to mention the usual analogue videos, the digital videos such as LVDS, DVI and the like.

### Embodiment 3

As mentioned previously, in the conventional liquid crystal display panel, the video signal is sequentially written in the pixels. Alternatively, since the liquid crystal display panel adopts the hold-type display method, in a moving picture display, there arises a situation that images of neighboring frames at an upper side and a lower side of the screen are overlapped to each other thus leading to an afterimage feeling at the time of performing the moving picture image.

Further, in performing the field sequential driving with the single-plate liquid crystal display panel, when the colors are driven in a time-division manner, there arises a drawback that the colors are liable to be easily mixed on an upper side and a lower side of the screen.

Accordingly, in this embodiment, by adding a thin film transistor (SWb) which functions as a switching element to each pixel of the liquid crystal display panel, the video signal which is sequentially written is temporarily stored in the inside of the panel and, thereafter, the video signal is written in accordance with the full-screen collective writing, the each-block collective writing or the two-stage high-speed writing.

According to the driving method of this embodiment, the response of the liquid crystal is substantially simultaneously completed at all portions of the inside of the screen of the liquid crystal display panel and hence, it is possible to obtain a large number of advantages including the countermeasure to cope with the film-like moving picture, the avoidance of color mixing at the time of single-plate field sequential driving, the counter measure to cope with the low withstand voltage process attributed to common inversion, the improvement of the moving picture display attributed to the insertion of black for an arbitrary period.

FIG. 17 is a circuit diagram showing an equivalent circuit of the liquid crystal display panel of the embodiment 3 of the present invention.

As shown in FIG. 17, in this embodiment, the two-stage constitution of the thin film transistor is provided by adding the thin film transistor (SWb) which functions as the switching element to each pixel

Here, in FIG. 17, D1 to Dn indicate drain lines, G1 to Gm indicate gate lines, TG1 indicates a trigger line, Ca(m,n) indicates a drain-line capacitance, Cb(m,n) indicates a first capacitive element, and Cc(m,n) indicates a second capacitive element. Here, the relationship among Ca, Cb, Cc is set as (Ca>Cb>Cc) with a ratio which makes a charge share of capacitor ignorable.

In this embodiment, by applying a line selection signal of High level (simply referred to as “H level” hereinafter) to the gate line (G1), the video signal inputted from the drain lines (D1 to Dn) is temporarily stored in the first capacitive element (Cb (1,1) to Cb (1,n)) through the thin film transistors (SWa (1,1) to SWa (1,n)).

During one frame, by sequentially applying a line selection signal of H level to the gate lines (G1 to Gm), the above-mentioned processing is performed with respect to all first capacitive elements (Cb(m,n)), and the video signal inputted from the drain signal lines (D1 to Dn) is temporarily stored in all first capacitive elements (Cb(m,n)).

Thereafter, by applying a H-level trigger pulse to the trigger line (TG1), the video signal which is held in the first capacitive element (Cb(m,n)) is written in the second capacitive element (Cc(m,n)) collectively through the thin film transistors (SWb(1,l) to SWb(1,n).

FIG. 18 is a circuit diagram showing an equivalent circuit of a modification of the liquid crystal display panel of the embodiment 3 of the present invention.

In the example shown in FIG. 18, a thin film transistor (SWc) is added to the constitution shown in FIG. 17 thus forming the three stage constitution of the thin film transistors.

Here, in FIG. 18, symbol TG2 indicates a reset line, and symbol SG indicates an external signal line. By applying a given voltage to the external signal line (SG) and by applying a reset pulse to the reset line (TG2), it is possible to periodically turn on the thin film transistor (SWc) thus periodically resetting a charge of the second capacitive element (Cc). Accordingly, it is possible to transmit the voltage of the first capacitive element (Cb) to the second capacitive element (Cc) in a more reliable manner.

Further, by supplying a black gray scale voltage to the external signal line (SG) and, at the same time, by applying the reset pulse to the reset line (TG2) so as to turn on the thin film transistor (SWc), the insertion of black is facilitated thus improving the moving picture display characteristics.

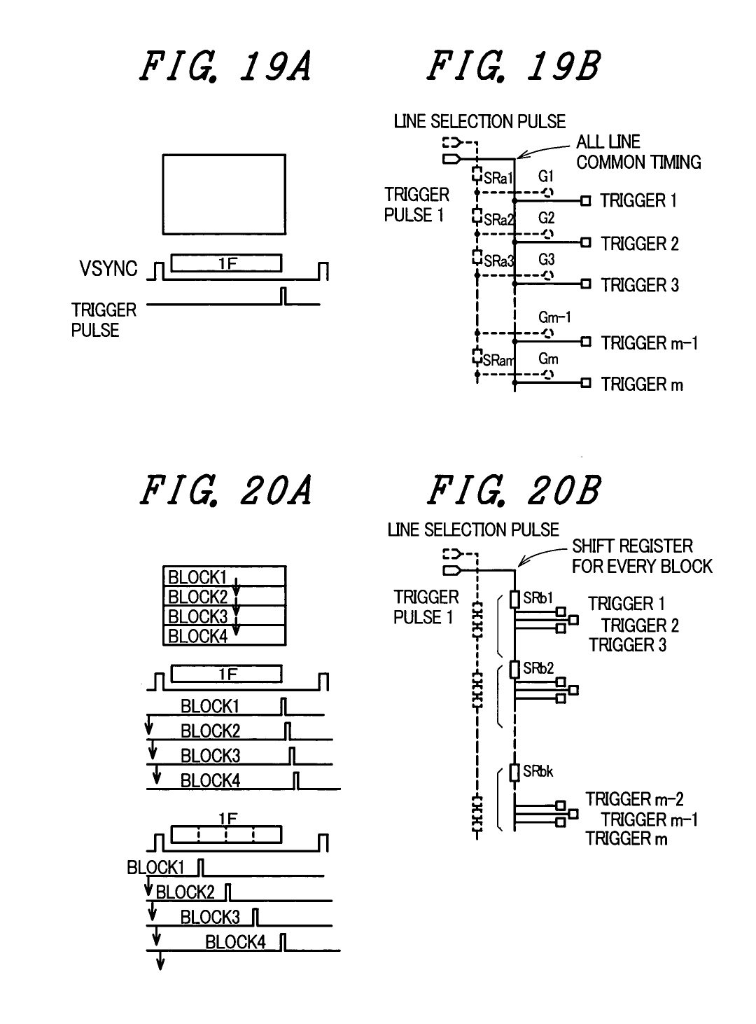

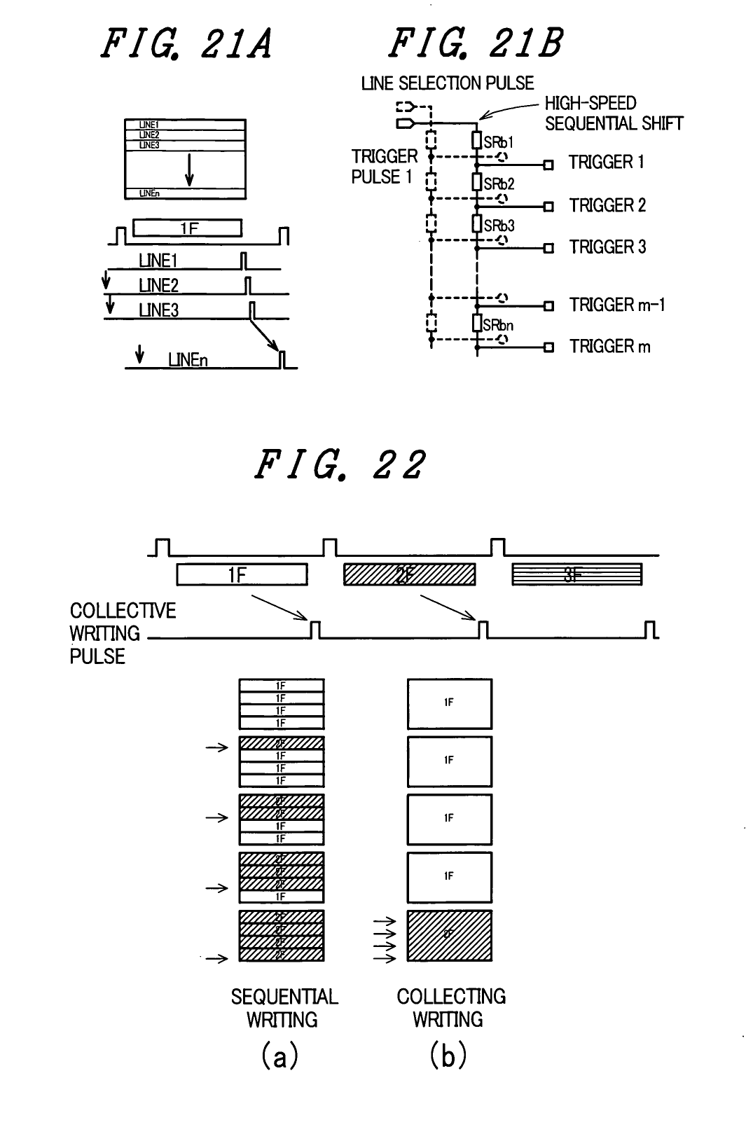

FIG. 19 to FIG. 21 are views, in this embodiment, for explaining a method for collectively writing the video signal to the second capacitive element (Cc(m,n)) of the respective pixels, wherein FIG. 19 shows the full-screen collective writing, FIG. 20 shows the each-block collective writing, and FIG. 21 shows the high-speed sequential writing.

Here, in FIG. 19 to FIG. 21, a quadrangular shape in which “1F” is described expresses one frame and the video signal which is inputted from the drain lines (D1 to Dn) during this one frame is temporarily stored in the first capacitive elements (Cb(m,n)) of the respective pixels.

In FIG. 19A and FIG. 19B, the video signal which is inputted from the drain lines (D1 to Dn) during the one frame is temporarily stored in the first capacitive elements (Cb(m,n)) of the respective pixels and, thereafter, a trigger pulse of H level is applied to the thin film transistors (SWb) of the respective pixels and hence, it is possible to collectively write the video signal to the second capacitive element (Cc(m,n)) of the respective pixels.

In FIG. 20A and FIG. 20B, the video signal which is inputted from the drain lines (D1 to Dn) during the one frame is temporarily stored in the first capacitive elements (Cb(m,n)) of the respective pixels and, thereafter, a trigger pulse of H level is sequentially applied to the thin film transistors (SWb) of the respective pixels of every block and hence, it is possible to collectively write the video signal to the second capacitive element (Cc (m,n)) of the respective pixels for every block (for example, a backlight unit or the like).

In this case, as shown in FIG. 20B, for example, shift registers (SRb1 to SRbk) are provided for respective blocks and the trigger pulse of H level applied to the trigger line (TG1) may be delayed using the above-mentioned shift registers (SRb1 to SRbk).

In FIG. 21A and FIG. 21B, the video signal which is inputted from the drain lines (D1 to Dn) during the one frame is temporarily stored in the first capacitive elements (Cb(m,n)) of the respective pixels and, thereafter, a trigger pulse of H level is sequentially applied to the thin film transistors (SWb) of the respective pixels for every display line and hence, it is possible to sequentially write the video signal to the second capacitive element (Cc(m, n)) of the respective pixels for every display line at a high speed.

In this case, as shown in FIG. 21B, for example, shift registers (SRb1 to SRbm) are provided for respective display lines and the trigger pulse of H level applied to the trigger line (TG1) may be delayed using the above-mentioned shift registers (SRb1 to SRbm).

FIG. 22 is a view for explaining the change of the image displayed in the inside of the screen when the collective writing according to this embodiment and the conventional sequential writing are performed.

In the case of the conventional sequential writing, as shown in FIG. 22A, the video signal is sequentially written in the respective pixels of 1 display line for every 1 display line and hence, the image of the preceding frame (1F) and the image of the present frame (2F) exist in a mixed form in the inside of the screen.

To the contrary, in the collective writing according to this embodiment, as shown in FIG. 22B, the video signal is written in all pixels collectively during one frame and hence, in the inside of the screen, the image of the preceding frame (1F) and the image of the present frame (2F) are completely separated and hence, it is possible to realize the image display with small afterimage feeling with respect to the moving picture display.

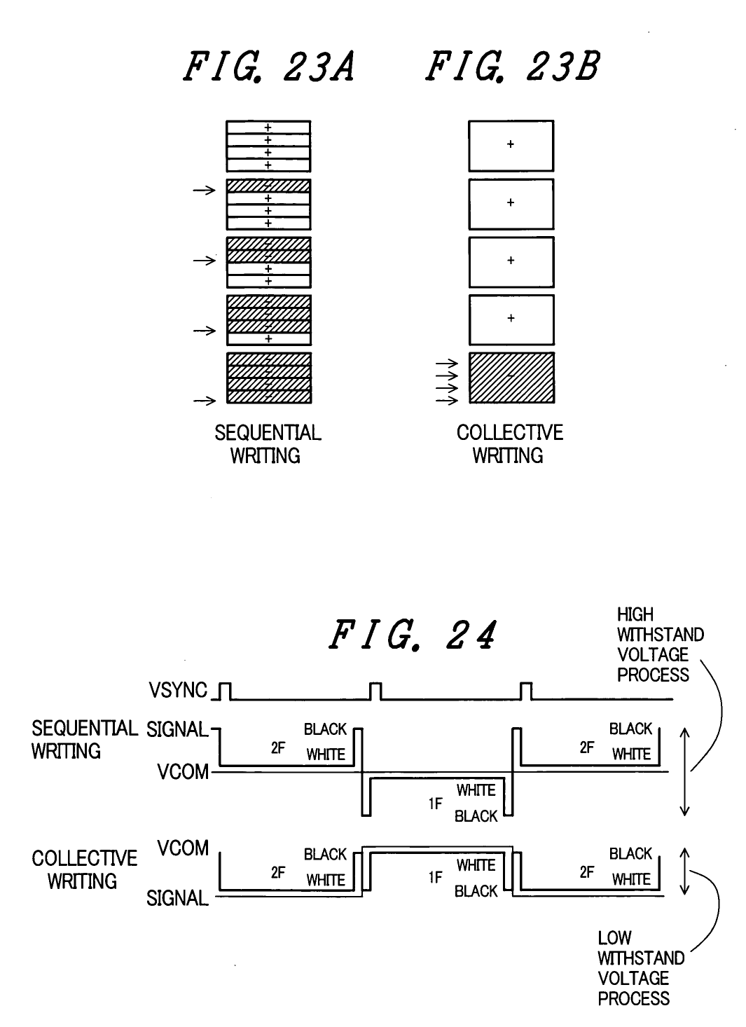

FIG. 23 is a view for explaining the change of polarity of the voltage held in the respective pixels for respective display lines when the collective writing according to this embodiment and the conventional sequential writing are performed.

In the case of the conventional sequential writing, as shown in FIG. 23A, the video signal is sequentially written in the respective pixels of one display line for every one display line and hence, as the voltage polarities in the inside of the screen, the positive polarity and the negative polarity exist in a mixed form.

Accordingly, with respect to the common voltage (VCOM) which is applied to the common electrode, as shown in FIG. 24, it is necessary to ensure a fixed voltage and hence, a voltage which is twice or more as large as an amplitude of the video signal is inputted to the transistors in the inside of drivers (103R, 103G, 103B shown in FIG. 10, for example) whereby high withstand voltage transistors which are manufactured by a high withstand process become necessary. Here, in FIG. 24, the signals used in a normally white display are illustrated.

To the contrary, in the collective writing according to this embodiment, as shown in FIG. 23B, the video signal is written in all pixels collectively during one frame and hence, the polarity of voltage in the inside of the screen always assumes the same polarity and hence, as shown in FIG. 24, it is possible to drive the pixels in a common inversion driving method whereby it is possible to use the transistors which are manufactured by a low withstand voltage process as the transistors in the inside of drivers (103R, 103G, 103B shown in FIG. 10, for example).

Next, a novel driving method of the common inversion driving method which realizes the collective writing according to this embodiment is explained.

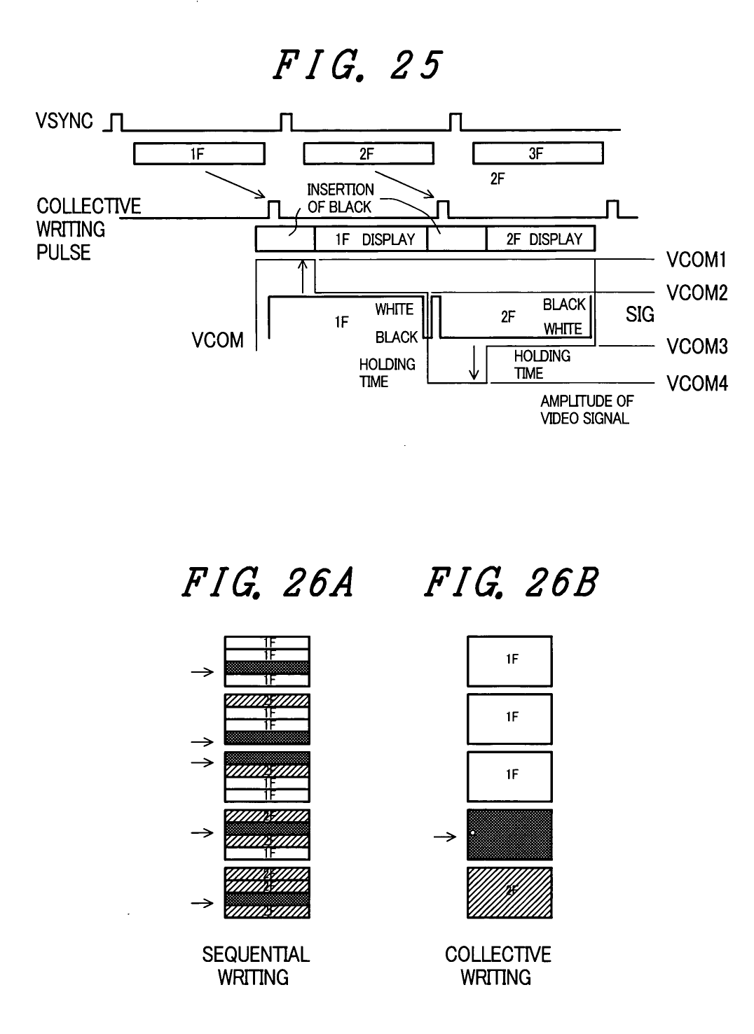

FIG. 25 is a view for explaining the modification of the driving method of this embodiment.

In performing the normally white display, when the voltage difference between the voltage of the pixel electrode of each pixel and the common voltage (VCOM) is small, the white display is performed, while when the voltage difference is large, the black display is performed. As shown in FIG. 25, the voltage level of the common voltage (VCOM) is changed such that the voltage difference between the voltage of the pixel electrode of each pixel and the common voltage (VCOM) is increased in synchronism with the driving timing (here, in synchronism with the collective writing). Accordingly, it is possible to display the black in the inside of the screen for a given period of one frame.

In this manner, according to this embodiment, it is possible to insert the black without writing the black video signal and hence, the driving close to the impulse-type driving can be realized. Accordingly, in performing the motion display, it is possible to realize the image display with small afterimage feeling.

This provision is advantageous in a projection-type panel which cannot perform the ON-OFF by the backlight. However, in the case shown in FIG. 25, four voltage levels are necessary as the voltage level of the common electrode.

Further, with respect to the position of the insertion of black, it is possible to insert the black at an arbitrary position irrespective of the video signal. Further, it is possible to change the positive polarity period and the negative polarity period by displacing the position at which the polarity of the common voltage (VCOM) is inverted.

FIG. 26A and FIG. 26B are views for explaining the driving method shown in FIG. 25 and the writing of the black video signal in the conventional sequential writing.

As shown in FIG. 26A, in the conventional sequential writing, when the black video signal is written, the drive frequency becomes faster and the operation also becomes complicated. Here, in FIG. 26, a portion indicated by an arrow (→) expresses a portion into which the black video signal is written.

To the contrary, according to this embodiment, it is possible to insert the black video signal to all pixels within a given period (for example, during a period in which the liquid crystal is in a response transitional state) and hence, the insertion of black can be easily performed.

Here, the insertion of black can be performed by the method which writes the black video signal or the method which turns off the backlight.

In this embodiment, when the black video signal is written, in the constitution shown in FIG. 18, a black gray scale voltage may be applied to an external signal line (SG) and, at the same time, a reset pulse is applied to a reset line (TG2) so as to turn on a thin film transistor (SWc).

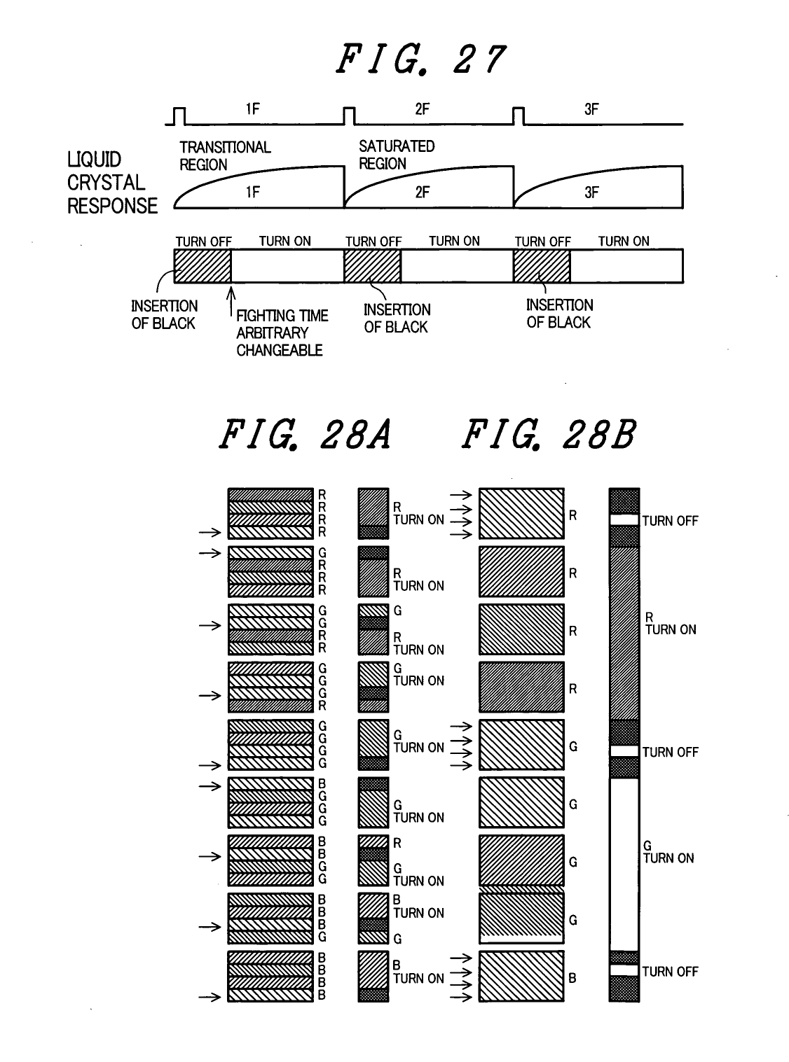

FIG. 27 is a view showing a timing chart when the black is inserted by turning off the backlight.

As shown in FIG. 27, in this embodiment, since the response of the liquid crystal in the inside of the screen is started simultaneously due to the full-screen collective writing, it is possible to insert the black by turning off the backlight within a given period (for example, during the period in which the liquid crystal is in a response transitional state) for every frame.

Further, the collective writing according to this embodiment allows the single-plate field sequential driving to be performed easily.

FIG. 28 is a view for explaining the single-plate field sequential driving in the collective writing according to this embodiment and in the conventional sequential writing. Here, in FIG. 28, the gray scale is expressed such that the color is weak immediately after the application of the voltage to the liquid crystal and the color is made thicker in accordance with the response in a pseudo manner.

In the single-plate field sequential driving, the video signals within one frame are further subjected to the time division and hence, the video signals are written by dividing the video signals into red (R), green (G) and blue (B) and color filters are scrolled in conformity with the response of the liquid crystal.

In performing the single-plate field sequential driving by the conventional sequential writing, as shown in FIG. 28A, the video signal is sequentially written in the respective pixels of 1 display line for every 1 display line and hence, the video signals for red (R) and green (G) are mixed and, at the same time, it is necessary to scroll the color filters in conformity with the response of the liquid crystal whereby the operation becomes complicated.

To the contrary, in case of the collective writing according to this embodiment, as shown in FIG. 28B, the video signals are collectively written in all pixels and hence, the video signals for red (R) and green (G) are completely separated whereby it is possible to realize the video display with no color mixing in the single-plate field sequential driving.

Further, in case of performing the single-plate field sequential driving using the conventional sequential writing, when the black is inserted, the operation becomes complicated as indicated by an arrow (→) in FIG. 28A. In this embodiment, however, as indicated by an arrow (→) in FIG. 28B, by turning off the backlight in a response transitional state of liquid crystal, it is possible to insert black during a time in which the efficiency of the liquid crystal is not good.

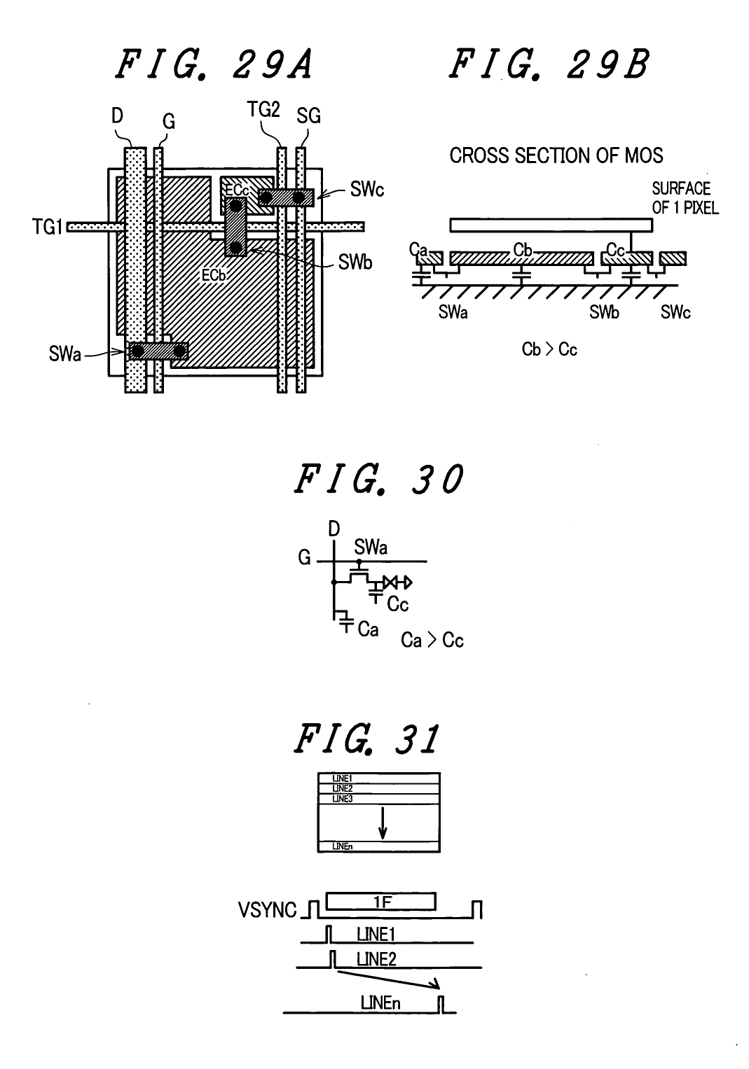

FIG. 29A and FIG. 29B are schematic views for explaining the manner of constituting 1 pixel of the liquid crystal display panel shown in FIG. 17, wherein FIG. 29A is a view as viewed from above and FIG. 29B is a cross-sectional view.

In these drawings, symbol ECb indicates one electrode of the first capacitive element (Cb) and symbol ECc indicates one electrode of the second capacitive element (Cc).

Although the present invention made by inventors of the present invention has been explained based on the above-mentioned embodiments, it is needless to say that the present invention is not limited to the above-mentioned embodiments and various modifications can be made without departing from the gist of the present invention.

What is claimed is:

1. A liquid crystal display device comprising: a liquid crystal display panel including a plurality of pixels which are arranged in a matrix array; and
a drive circuit which controls and drives the respective pixels; wherein
each pixel includes a pixel electrode, a pixel transistor, a first transistor which is connected between the pixel transistor and the pixel electrode, and a capacitive element which is connected between the pixel transistor and the first transistor, and
the drive circuit sequentially turns on the pixel transistors of the respective pixels on each display line thus sequentially writing a video voltage into the capacitive elements of the respective pixels and, thereafter, turns on the first transistors of the respective pixels simultaneously thus collectively writing the video voltage written in the capacitive elements of the respective pixels into pixel capacitances.

2. A liquid crystal display device according to claim 1, wherein
the liquid crystal display panel includes a counter electrode which faces the respective pixel electrodes in an opposed manner with liquid crystal therebetween,
the drive circuit applies a second common voltage to the counter electrode within a given period and applies a first common voltage to the counter electrode within other period,
the given period includes a point of time at which the drive circuit turns on the first transistors of the respective pixels so as to write the video voltage to the respective pixel capacitances, and
when the second common voltage is applied to the counter electrode, black is displayed on the liquid crystal display panel.

3. A liquid crystal display device comprising:
a liquid crystal display panel including a plurality of pixels which are arranged in a matrix array; and
a drive circuit which controls and drives the respective pixels; wherein
each pixel includes a pixel electrode, a pixel transistor, a first transistor which is connected between the pixel transistor and the pixel electrode, and a capacitive element which is connected between the pixel transistor and the first transistor, and
the drive circuit sequentially turns on the pixel transistors of the respective pixels on each display line thus sequentially writing a video voltage into the capacitive elements of the respective pixels and, thereafter, turns on the first transistors of the respective pixels on a plurality of display lines sequentially for every plurality of display lines thus writing the video voltage written in capacitive elements of the respective pixels on the plurality of the respective display lines into the respective pixel capacitances.

4. A liquid crystal display device comprising:
a liquid crystal display panel including a plurality of pixels which are arranged in a matrix array; and
a drive circuit which controls and drives the respective pixels; wherein
each pixel includes a pixel electrode, a pixel transistor, a first transistor which is connected between the pixel transistor and the pixel electrode, and a capacitive element which is connected between the pixel transistor and the first transistor, and
the drive circuit sequentially turns on the pixel transistors of the respective pixels on each display line thus sequentially writing a video voltage into the capacitive elements of the respective pixels and, thereafter, turns on the first transistors of the respective pixels on each display line thus writing the video voltage written in the capacitive elements of the respective pixels into respective pixel capacitances.

5. A liquid crystal display device comprising:
a liquid crystal display panel including a plurality of pixels which are arranged in a matrix array; and
a drive circuit which controls and drives the respective pixels; wherein
each pixel includes a pixel electrode, a pixel transistor, a first transistor which is connected between the pixel transistor and the pixel electrode, and a capacitive element which is connected between the pixel transistor and the first transistor, and
the drive circuit sequentially turns on the pixel transistors of the respective pixels on each display line a plurality of times for every frame thus sequentially writing a video voltage into the capacitive elements of the respective pixels and, thereafter, turns on the first transistors of the respective pixels simultaneously thus collectively writing the video voltage written in the capacitive elements of the respective pixels into pixel capacitances.

6. A liquid crystal display device according to claim 1, wherein
the liquid crystal display device includes a backlight, and
the backlight is turned off within an arbitrary period including a point of time that the video voltage is written into the respective pixel capacitances by turning on the first transistors of the respective pixels.

7. A liquid crystal display device according to claim 6, wherein each pixel includes a second transistor which is connected between the first transistor and the pixel electrode, and
the drive circuit turns on the second transistor periodically.

8. A liquid crystal display device according to claim 7, wherein each pixel includes a second transistor which is connected between the first transistor and the pixel electrode, and
the drive circuit, before turning on the first transistor, turns on the second transistor thus writing a video voltage which allows a black display to the capacitive element of each pixel.

9. A projector comprising:
a light source;
a plurality of liquid crystal display panels which modify light irradiated from the light source; and
a screen to which the light modified by the respective liquid crystal display panels is projected, wherein
each liquid crystal display panel includes a plurality of pixels arranged in a matrix array and a drive circuit which controls and drives the respective pixels; and
each pixel includes a pixel electrode, a pixel transistor, a first transistor which is connected between the pixel transistor and the pixel electrode, and a capacitive element which is connected between the pixel transistor and the first transistor, and
the drive circuit sequentially turns on the pixel transistors of the respective pixels on each display line thus sequentially writing a video voltage into the capacitive elements of the respective pixels and, thereafter, turns on the first transistors of the respective pixels simultaneously thus collectively writing the video voltage written in the capacitive elements of the respective pixels into pixel capacitances.

10. A projector according to claim 9, wherein
the liquid crystal display panel includes a counter electrode which faces the respective pixel electrodes in an opposed manner with liquid crystal therebetween,
the drive circuit applies a second common voltage to the counter electrode within a given period and applies a first common voltage within other period,
the given period includes a point of time at which the drive circuit turns on the first transistors of the respective pixels so as to write the video voltage to the respective pixel capacitances, and
when the second common voltage is applied to the counter electrode, black is displayed on the liquid crystal display panel.

11. A projector comprising:
a light source;
a plurality of liquid crystal display panels which modify light irradiated from the light source; and
a screen to which the light modified by the respective liquid crystal display panels is projected, wherein
each liquid crystal display panel includes a plurality of pixels arranged in a matrix array and a drive circuit which controls and drives the respective pixels; and
each pixel includes a pixel electrode, a pixel transistor, a first transistor which is connected between the pixel transistor and the pixel electrode, and a capacitive element which is connected between the pixel transistor and the first transistor, and
the drive circuit sequentially turns on the pixel transistors of the respective pixels on each display line thus sequentially writing a video voltage into the capacitive elements of the respective pixels and, thereafter, turns on the first transistors of the respective pixels on a plurality of display lines sequentially for every plurality of display lines thus writing the video voltage written in capacitive elements of the respective pixels on the plurality of the respective display lines into the respective pixel capacitances.

12. A projector comprising:
a light source;
a plurality of liquid crystal display panels which modify light irradiated from the light source; and
a screen to which the light modified by the respective liquid crystal display panels is projected, wherein
each liquid crystal display panel includes a plurality of pixels arranged in a matrix array a drive circuit which controls and drives the respective pixels; and
each pixel includes a pixel electrode, a pixel transistor, a first transistor which is connected between the pixel transistor and the pixel electrode, and a capacitive element which is connected between the pixel transistor and the first transistor, and
the drive circuit sequentially turns on the pixel transistors of the respective pixels on each display line thus sequentially writing a video voltage into the capacitive elements of the respective pixels and, thereafter, turns on the first transistors of the respective pixels on each display line thus writing the video voltage written in the capacitive elements of the respective pixels into respective pixel capacitances.

13. A projector according to claim 9, wherein each pixel includes a second transistor which is connected between the first transistor and the pixel electrode, and
the drive circuit turns on the second transistor periodically.

14. A projector according to claim 9, wherein each pixel includes a second transistor which is connected between the first transistor and the pixel electrode, and
the drive circuit, before turning on the first transistor, turns on the second transistor thus writing a video voltage which allows a black display to the capacitive element of each pixel.

15. A projector comprising:
a light source;
a plurality of liquid crystal display panels which modify light irradiated from the light source; and
a screen to which the light modified by the respective liquid crystal display panels is projected, wherein
the orientation directions of the respective liquid crystal display panels are aligned on the screen.

16. A projector comprising:
a light source;
a plurality of liquid crystal display panels which modify light irradiated from the light source; and
a screen to which the light modified by the respective liquid crystal display panels is projected, wherein
the orientation direction of one liquid crystal display panel in the plurality of liquid crystal display panels differs from the orientation directions of other liquid crystal display panels.

17. A projector according to claim 16, wherein a line-symmetry relationship is established between the orientation direction of one liquid crystal display panel and the orientation directions of other liquid crystal display panels with respect to an arbitrary straight line.

18. A projector comprising:
a light source;
a plurality of liquid crystal display panels which modify light irradiated from the light source; and
a screen to which the light modified by the respective liquid crystal display panels is projected, wherein
the orientation directions of the respective liquid crystal display panels are aligned with an extending direction of one of opposedly facing sides out of four sides of the liquid crystal display panel.

19. A projector according to claim 18, wherein the plurality of liquid crystal display panels are three liquid crystal display panels allocated to red, green and blue respectively.

20. A projector according to claim 19, wherein the plurality of liquid crystal display panels includes a transmission-type liquid crystal display panel.

21. A projector according to claim 19, wherein the plurality of liquid crystal display panels includes a reflective liquid crystal display panel.

22. A projector comprising:
a light source;
a plurality of liquid crystal display panels which modify light irradiated from the light source;
a screen to which light modified by the respective liquid crystal display panels is projected; and
a control circuit which drives the respective liquid crystal display panel, wherein
the control circuit includes:
a pattern output circuit which generates and outputs an arbitrary pattern which is used in an inspection or a test; and
a still image output circuit which generates and outputs an arbitrary still image which is used in the inspection or the test.

23. A projector according to claim 22, wherein
the projector includes a first memory which stores a plurality of pattern data, and
the pattern output circuit includes a frame memory, means 1 which reads out given pattern data from the first memory and stores the given pattern data in the frame memory and, at the same time, reads out the given pattern data from the frame memory and generates a given pattern.

24. A projector according to claim 23, wherein
the pattern data stored in the first memory is pattern data corresponding to one vertical-stripe or lateral-stripe display line, and
the means 1 of the pattern output circuit repeatedly reads out the pattern data corresponding to one vertical-stripe or lateral-stripe display line stored in the frame memory, and generates a given vertical-stripe or lateral-strip pattern.

25. A projector according to claim 23, wherein
the pattern data stored in the first memory is pattern data corresponding to 1 unit block, and
the means 1 of the pattern output circuit repeatedly reads out the pattern data corresponding to 1 unit block stored in the frame memory and generates a given checkered pattern.

26. A projector according to claim 25, wherein the first memory is an EEPROM.

27. A projector according to claim 22, wherein
the projector includes a second memory which stores still image data, and
the still image output circuit includes an internal memory, and means 1 which reads out given still image data from the second memory and stores the still image data in the internal memory and, at the same time, reads out the still image data from the internal memory and generates a given still image.

28. A projector according to claim 27, wherein the second memory is a flash memory card.
